(19) United States
(12) Patent Application Publication
(10) Pub. No.: US 2003/0054140 A1
(43) Pub. Date: Mar. 20, 2003

(54) Printed matter, its application and production method therefor

(76) Inventor: Keizaburo Matsumoto, Fukuoka (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/030,099

(22) PCT Filed: Mar. 29, 2001
(86) PCT No.: PCT/JP01/02636

(30) Foreign Application Priority Data
May 18, 2000 (JP) 2000-146293

(51) Int. Cl. B32B 27/14

(52) U.S. Cl. 428/195

(57) ABSTRACT

A printed matter which employs commonly used printing paper as a substrate and is capable of economically and efficiently forming beautiful images of fixed information and variable information by using both printing method and ink jet recording method, characterized in that a receiving layer for an ink jet recording ink for printing variable information is formed on the entire or a part of the surface of a printing paper having fixed information printed by using a printing method selected from lithographic printing, relief printing and intaglio printing.

### TECHNICAL FIELD

The present invention relates to a printed matter having fixed information printed in a conventional printing method and having a receiving layer for an ink jet recording ink for printing variable information wherein a beautiful image having both fixed information and variable information can be formed efficiently thereon. The invention relates also to a printed matter having variable information printed in the receiving layer by an ink jet recording method and to a method for its production.

### BACKGROUND ART

The ink jet recording method utilizes piezo electric elements, thermal energy, electrical attraction force or the like as a method for spouting an ink. Even when any of the methods is used, this recording method does not need large-scale equipment. Moreover, the recording method has a feature that the images captured with personal computers or the like can be printed directly in any desired receptor. Therefore, this recording method is spreading quickly as a method that can print color image information easily However, very expensive exclusive paper is required in order to obtain beautiful printed matters since blurring or muddying occurs when printed on plain paper. The ink jet recording method can print only at a slow speed and the ink itself is expensive. For these reasons, the ink jet recording method is unsuitable for producing a large number of prints.

On the other hand, since a printing method using a printing ink (conventional printing method) can produce clear printed matters at a high speed using ink and printing paper of low cost, it is suitable for producing a large number of prints at once. However, in the case where different images are printed each in a small amount, since plates whose number is equal to that of the images are required, the cost of platemaking and the time for plate exchanging work increase, resulting in an increase in economical burden and loss of time.

These days, a method for producing efficiently large quantities of printed matters having variable information has been developed by taking advantage of the handiness of the ink jet recording method and the high speed performance of the conventional printing method. This is a method in which an image of fixed information is printed in a large number of prints by the usual printing method and variable information is printed afterwards in the required numbers of prints by the ink jet recording method. This method can produce printed matters having both fixed information and variable information far economically and far efficiently than the case where all information is printed by one of the methods.

However, as mentioned above, the attempt to obtain a beautiful image by the current ink jet recording method requires expensive exclusive papers. There is a problem that most of such exclusive papers are not suitable for the conventional printing method and cannot be used as they are.

Furthermore, as disclosed in JP, A, 8-230307 and the like, there is also a problem that a water-based ink for ink jet recording is repelled on the printed surface obtained by using offset printing ink (oil-based ink), resulting in failure to form any image.

The information to be printed afterwards by the ink jet recording method is restricted to mainly a simple text such as a lot number and production date of the content and the use-by date in food products applications, which is not satisfactory in the field where the beauty of patterns or the like is required.

However, recently, in leaflets of supermarkets or volume retailers of chain systems, there is increasing demand for printed matters wherein fixed image information such as pictures of articles to be commonly sold in all the chain stores is printed by the usual printing method and afterwards pictures of articles for special sale different between every chain stores or designed image information of even letters such as prices are printed by the ink jet recording method. Therefore, even in the ink jet recording, an image quality comparable to that of the conventional printing has been required.

For example, JP, A, 11-78219 or the like discloses coated paper that has receivability to both a printing ink and an ink jet recording ink and an attempt to make quality of image equal with both of the inks is also performed.

However, there is an economical disadvantage problem with this method because of the necessity to apply an expensive coating composition comprising special materials onto the entire surface of paper. Furthermore, there still remains a problem that since an ink jet recording ink is repelled by a surface printed with an oil-based ink, the oil-based ink cannot be printed in the area where variable information will be printed afterwards and therefore the design is limited.

Thus, today, the use of the both methods, the conventional printing and the ink jet recording, can increase the production efficiency of printed matters having variable information, but it is not possible to form beautiful images economically by the both methods.

An object of the present invention is to solve the above problems and to provide printed matters having beautiful images which have both fixed information and variable information printed by both the conventional printing method and the ink jet recording method with excellent efficiency and also economy.

### DISCLOSURE OF INVENTION

That is, the present invention provides the following printed matters, applications thereof and production methods thereof.

(1) A printed matter having a receiving layer for an ink jet recording-ink for printing variable information formed on the entire or a part of the surface of a printing paper having fixed information printed by using a printing method selected from lithographic printing, relief printing and intaglio printing.

(2) The printed matter according to item (1), wherein the receiving layer for an ink jet recording ink comprises at least two layers containing different ingredients respectively, at least one layer of them being a receiving layer comprising an ink-absorbing resin as its main ingredient and at least the other layer of them being a receiving layer comprising an ink-fixing resin as its main ingredient.

(3) The printed matter according to item (2), wherein the receiving layer comprising an ink-absorbing resin as its main ingredient is a receiving layer for an ink jet recording ink containing at least one ink-absorbing resin selected from the group consisting of proteins, starches, celluloses, polyvinyl alcohols, polyvinyl acetals and polyvinylpyrrolidones.

(4) The printed matter according to item (2) or item (3), wherein the receiving layer comprising an ink-absorbing resin as its main ingredient is a receiving layer for an ink jet recording ink further containing a filler.

(5) The printed matter according to item (2) or item (3), wherein the receiving layer comprising an ink-fixing resin as its main ingredient is a receiving layer for an ink jet recording ink containing at least one ink-fixing resin selected from the group consisting of resins having a cationic group in their molecules.

(6) The printed matter according to any one of items (1) to (5), wherein the receiving layer is formed at least on the print film of the ink used for printing the fixed information.

(7) The printed matter according to item (6), wherein the fixed information is printed with an oil-based ink by using the lithographic printing method or the relief printing method, and the receiving layer for an ink jet recording ink is formed at least on the print film of the oil-based ink, the receiving layer comprising one layer or two or more layers containing different ingredients, wherein the layer adjoining the print film of the oil-based ink contains a film-forming acrylic resin obtained by emulsion polymerizing monomers containing 15% by weight or more of a (meth)acrylic ester compound containing an alkyl group having 8 to 18 carbon atoms.

(8) The printed matter according to item (6) or item (7), wherein the fixed information is printed with an oil-based ink by using the lithographic printing method or the relief printing method, and the receiving layer for an ink jet recording ink is formed at least on the print film of the oil-based ink, the receiving layer comprising one layer or two or more layers containing different ingredients, wherein the layer adjoining the print film of the oil-based ink is formed from a coating agent further containing 1 to 8% by weight of at least one film forming-improving agent selected from the group consisting of the compounds represented by the following general formulas (1) to (3):

Y¹—O—(X¹—O)n-Z¹ (1)

Y²—O—X²—O-Z² (2)

Y³—OCO—X³—COO—Z³ (3)

wherein X¹ denotes an alkylene group having 2 to 4 carbon atoms, Y¹ and Z¹ each denote an alkyl group having 1 to 4 carbon atoms, n denotes an integer of 1 to 4; X² denotes an alkylene group having 2 to 8 carbon atoms, Y² denotes H or an alkyl group having 1 to 11 carbon atoms, Z² denotes an alkyl group having 4 to 11 carbon atoms or an acyl group having 4 to 11 carbon atoms with the proviso that Y² is H, Z² denotes an acyl group having 4 to 11 carbon atoms with the proviso that Y² is an alkyl group having 1 to 3 carbon atoms, Z² denotes an acyl group having 2 to 11 carbon atoms with the proviso that Y² is an alkyl group having 4 to 11 carbon atoms; X³ denotes a residual group of an aliphatic dibasic acid or an aromatic dibasic acid; and Y³ and Z³ each denote an alkyl group having 1 to 11 carbon atoms.

(9) A printed matter, characterized in that variable information is printed by an ink jet recording method on the receiving layer recited in any one of items (1) to (8).

(10) A method for producing the printed matter according to any one of items (2) to (8), characterized by printing fixed information and then forming the receiving layer for an ink jet recording ink with a coater or a printer by an in-line system.

(11) A method for producing the printed matter according to item (7) or item (8), characterized by providing the receiving layer for an ink jet recording ink with a coater or a printer by an in-line system on a printed surface still in a wet condition immediately after printing the fixed information with an oil-based ink.

(12) The method for producing a printed matter according to item (10) or item (11), wherein the receiving layer for an ink jet recording ink is formed with a coater equipped with an anilox roll and a rubber roll.

Hereafter, the present invention will be described in more detail.

As the printing paper to be used in the printed matter of the present invention, general printing papers to which an ink can be printed well by various kinds of printing methods, typified by art paper, coated paper, cast-coated paper, luster paper, woodfree paper and medium-quality paper, can be used with no particular limitations.

As the method for printing fixed information in the present invention, a method of using conventional printers based on any printing method selected from the lithographic printing, relief printing and intaglio printing can be used. Moreover, as a printing ink, any of general oil-based ink, solvent-based ink and water-based ink can be used. Especially, the lithographic printing and intaglio printing are the printing methods suitable for obtaining a beautiful printed matter, which is the object of the present invention, since these printing methods can print minute images. Moreover, print patterns may be formed by a “selective printing” wherein no print image is formed in the area where images will be printed by the ink jet printing method afterwards.

Next, in the present invention, for forming a receiving layer for an ink jet recording ink (hereinafter referred simply to as “receiving layer”) on the print surface of the printed matter obtained by the aforesaid printing methods, a coating agent which is obtained by dissolving or dispersing the following materials for constituting the receiving layer in an aqueous medium and which can form a smooth receiving layer on the printed surface by coating or printing can be suitably used.

As the resin for constituting the receiving layer, resins having a wetting function to water (ink-absorbing resins) and resins having a function of fixing dyes or pigments in inks for ink jet recording (ink-fixing resins) are suitable. Examples of the former ink-absorbing resins are proteins such as casein and synthetic proteins, various kinds of starches such as oxidized starch and esterified starch, celluloses such as carboxymethyl cellulose and hydroxymethyl cellulose, polyvinyl alcohols, polyvinyl acetals and polyvinylpyrrolidones. Examples of the latter ink-fixing resins are polyvinyl alcohols having a cationic group, acrylic resins having a cationic group and acrylamide resins having a cationic group.

Furthermore, in order to improve the water resistance of the receiving layer, it is also possible to incorporate aqueous polyurethane resins, aqueous polyester resins, epoxy resins, or the like.

As a filler to be used for forming the receiving layer, inorganic fillers such as silica, alumina sol, barium sulfate, calcium carbonate, clay and talc, and organic fillers such as polystyrene fine particles and polyethylene fine particles can be exemplified. The desirable form of the filler is a layered shape or a plate-like shape. Furthermore, porous fillers are more desired.

As an aqueous medium, water or water admixed with a water-miscible organic solvent such as lower alcohols or various additives such as surfactant or antifoaming agent, as needed, can be used.

When the receiving layer is formed on the entire surface of a printed matter or on the printing ink film of the printed matter even in the case that the receiving layer is formed partially on the printed matter, the receiving layer preferably has a smooth continuous surface and preferably is as transparent as possible so as not to conceal printed images. Furthermore, the receiving layer is preferably formed from a coating agent that does not dissolve the printing ink so that the printed surface would not cause blurring or bleeding. On the other hand, when forming a receiving layer only on the non-printed surface of the printed matter, any coating agent for forming a transparent receiving layer and an opaque receiving layer can be used.

Moreover, the receiving layer may comprise either one layer, or two or more layers laminated. In the case of a receiving layer comprising a single layer, only an ink-absorbing resin, only an ink-fixing resin, or a mixture of the ink-absorbing and ink-fixing resins may be used as the resin component of the layer. In the case of a receiving layer comprising two or more layers laminated, possible methods include a method wherein an lower layer where an importance is placed on the adhesiveness to a printing paper or a print surface and an upper layer where an importance is placed on the ability to receive an ink jet recording ink are formed separately, and a method in which a function layer having the ability to absorb the liquid component of an ink jet recording ink and another function layer having the ability to fix the ink jet recording ink are formed separately. Particularly, it is desirable to use a receiving layer comprising an ink-absorbing resin as the lower layer and to use a receiving layer containing an ink-fixing resin as the upper layer, from the viewpoint that when an ink jet recording ink is printed, it is not blurred and a clear image is formed.

The content of the resin component and that of the filler in the receiving layer are desirably about 50 to 95% by weight for an ink-absorbing resin and/or an ink-fixing resin and about 5 to 50% by weight for the filler, based on the weight of the receiving layer after drying.

The coating amount of the receiving layer (the coating amount after drying, hereinafter the same) is not particularly limited. It is appropriately selected from the range of 1 to 30 g/m² for each layer both in the case of a receiving layer comprising one layer and in the case of a receiving layer comprising two or more layers.

Furthermore, in the present invention, especially in the case that fixed information is printed with an oil-based printing ink, when a coating agent having low contents of the aforesaid ink-absorbing resin, ink-fixing resin and filler is used, it is difficult to form a film from the coating agent on the oil-based ink film due to the low viscosity of the coating agent and repulsion between water and oil. On the other hand, when a coating agent having high contents of the aforesaid ingredients is used, the repulsion of the coating agent is reduced due to its high viscosity but its application itself becomes difficult.

Then, for forming continuously a smooth receiving layer on a print film of an oil-based ink by using a low-viscosity coating agent which has easy application property, suitable methods include a method using an acrylic resin for film forming obtained by emulsion polymerizing monomers containing 15% by weight or more of one or more of (meth)acrylic ester compounds with an alkyl group having 8 to 18 carbon atoms and a method using a film forming-improving agent represented by the following general formulas (1) to (3):

Y¹—O—(X¹—O)n-Z¹ (1)

Y²—O—X²—O-Z² (2)

Y³—OCO—X³—COO-Z³ (3)

Here, X¹ denotes an alkylene group having 2 to 4 carbon atoms, Y¹ and Z¹ each denote an alkyl group having 1 to 4 carbon atoms, and n denotes an integer of 1 to 4. X² denotes an alkylene group having 2 to 8 carbon atoms and Y² denotes H or an alkyl group having 1 to 11 carbon atoms. When Y² is H, Z² denotes an alkyl group having 4 to 11 carbon atoms or an acyl group having 4 to 11 carbon atoms. When Y²is an alkyl group having 1 to 3 carbon atoms, Z² denotes an acyl group having 4 to 11 carbon atoms. When Y² is an alkyl group having 4 to 11 carbon atoms, Z² denotes an acyl group having 2 to 11 carbon atoms. X³ denotes a residual group of an aliphatic dibasic acid or an aromatic dibasic acid, and Y³ and Z³ each denote an alkyl group having 1 to 11 carbon atoms.

Examples of the alkylene group having 2 to 4 carbon atoms represented by X¹ include an ethylene group, a trimethylene group, a propylene group, a tetramethylene group and a butylene group. Examples of the alkylene group having 2 to 8 carbon atoms represented by X² include an ethylene group, a trimethylene group, a propylene group, a tetramethylene group, a butylene group, a pentamethylene group, a hexamethylene group, an octamethylene group and a 2-ethylhexylene group. Examples of the aliphatic dibasic acid that provides the residual group represented by X³ include aliphatic dibasic acids having 4 to 10 carbon atoms such as succinic acid, adipic acid, azelaic acid and sebacic acid. Examples of the aromatic dibasic acid that provides the residual group represented by X³ include phthalic acid, isophthalic acid and terephthalic acid. Examples of the alkyl group having 1 to 4 carbon atoms represented by Y¹ or Z¹ include a methyl group, an ethyl group, a propyl group, an isopropyl group, a butyl group, an isobutyl group and a sec-butyl group. Examples of the alkyl group having 1 to 11 carbon atoms represented by Y² include a methyl group, an ethyl group, a propyl group, an isopropyl group, a butyl group, an isobutyl group, a sec-butyl group, a pentyl group, a hexyl group, an octyl group, a 2-ethylhexyl group, a decyl group and an undecyl group. Examples of the alkyl group having 4 to 11 carbon atoms represented by Z² include a butyl group, an isobutyl group, a sec-butyl group, a pentyl group, a hexyl group, an octyl group, a 2-ethyl hexyl group, a decyl group and an undecyl group. Examples of the carboxylic acid that provides the acyl group having 2 to 11 carbon atoms represented by Z² include acetic acid, propionic acid, butyric acid, pentanoic acid, hexanoic acid octanoic acid, decanoic acid and an undecanoic acid. Examples of the alkyl group having 1 to 11 carbon atoms represented by Y³ or Z³ includes a methyl group, an ethyl group, a propyl group, an isopropyl group, a butyl group, an isobutyl group, a sec-butyl group, a pentyl group, a hexyl group, an octyl group, a 2-ethylhexyl group, a decyl group and an undecyl group.

Examples of the (meth)acrylic ester compound with an alkyl group having 8 to 18 carbon atoms to be used for the synthesis of the aforesaid acrylic resins for film forming include n-octyl (meth)acrylate, 2-ethylhexyl (meth)acrylate, n-decyl (meth)acrylate, lauryl (meth)acrylate, stearyl (meth)acrylate. These may be copolymerized with (meth)acrylic ester compounds having 1 to 6 carbon atoms (for example, methyl (meth)acrylate, ethyl (meth)acrylate, propyl (meth)acrylate, butyl (meth)acrylate and hexyl (meth)acrylate), other acrylic monomers, styrenic monomers, and the like.

A coating layer comprising the aforesaid acrylic resin alone may be formed on a printing ink film, followed by further forming thereon a receiving layer containing an ink-absorbing resin and/or an ink-fixing resin, or a receiving layer in which the aforesaid acrylic resin is contained together with the ink-absorbing resin and/or the ink-fixing resin may be formed on the printing ink film. In the former case, it is desirable that the acrylic resin coating agent contains a filler. The coating amount of the coating agent (the coating amount after drying, hereinafter the same) is suitably selected from the range of 2 to 20 g/m². In the latter case, the acrylic resin is contained in the receiving layer adjoining the print film of an oil-based ink. Furthermore, in the case where an acrylic resin for film forming is used together with other resins, the content of the acrylic resin for film forming can be determined depending upon the relationship with the viscosity of the coating agent, or the like. However, in order to obtain a coating agent having a low viscosity and a good film forming property, it is desirable to satisfy the following condition. That is, a good result is obtained when the proportion of the (meth)acrylic ester compound having an alkyl group having 8 to 18 carbon atoms used as a material for synthesizing the aforesaid acrylic resin is 15% by weight or more , based on all the resins including the other resin used together.

Typical examples of the afore-mentioned film forming-improving agents are as follows. Examples of the compounds represented by the general formula (1) are dimethyl ether, diethyl ether or dibutyl ether of ethylene glycol, diethylene glycol or triethylene glycol; dimethyl ether, diethyl ether or dibutyl ether of propylene glycol, dipropylene glycol or tripropylene glycol; dimethyl ether, diethyl ether or dibutyl ether of butylene glycol, dibutylene glycol or tributylene glycol. Examples of the compounds represented by the general formula (2) are monobutyl ether, monohexyl ether, monooctyl ether or monodecyl ether of ethylene glycol, propylene glycol, butylene glycol or 2-ethylhexylene glycol, monobutyric ester, monohexanoic ester, monooctanoic ester or monodecanoic ester of ethylene glycol, propylene glycol, butylene glycol or 2-ethylhexylene glycol; ethylene glycol methyl ether butyrate, propylene glycol ethyl ether butyrate; ethylene glycol butyl ether acetate and propylene glycol butyl ether butyrate. Examples of the compounds represented by the general formula (3) are dimethyl ester, diethyl ester or dibutyl ester of succinic acid, adipic acid or phthalic acid.

These film forming-improving agents can provide good effects when the film forming-improving agent is dissolved or mixed in an emulsion condition into a coating agent for forming a receiving layer in an amount of about 1 to 8% by weight, optionally using a water-soluble organic co-solvent such alcohols or ketones having a low molecular weight or the like, as needed.

As means for forming a receiving layer, various types of coaters such as a roll coater, a gravure coater, a flexocoater, a blade coater, a rod coater and an air knife coater can be used. Printing units contained in printers used in the aforementioned various types of printing methods can also be used. A receiving layer may be formed over the entire surface of a printed matter, or may also be formed partially on the surface of the printed matter. When a gravure coater, a flexocoater or various printing methods are used, a receiving layer can be formed partially. Moreover, the use of a flexo-style coating machine equipped with an anilox roll and a rubber roll is more desirable since such a machine can easily form a receiving layer having a large thickness.

Furthermore, the use of a coating agent that can form a smooth receiving layer on the film of a printing ink even under the condition where the printing ink has not been fully dried is more suitable since the printing of the printing ink and the formation of the receiving layer can be performed at a series of processes (in-line method). Particularly, when fixed information is printed with an oil-based printing ink, the formation of a coating for a receiving layer by the in-line method becomes still more difficult. However, by the use of the aforementioned film-forming acrylic resin or a film-forming-improving agent, a good receiving layer can be formed in the in-line method.

As such a method for forming a receiving layer in the in-line method, a method in which the rear unit of a printing machine is used or a method in which a separate printer or coater is combined with the printing machine for the printing ink is employed. In addition, even a method in which a receiving layer is formed afterwards by using a printer or a coater in a step different from a printing step (off-line method) can be used, there is no inconvenience at all.

In the present invention, when further printing variable information, the information is printed by an ink jet recording method on the receiving layer provided in the previous step.

Although water-based inks are in the mainstream of ink jet recording ink, oil-based inks can also be used.

All steps including the printing of fixed information, the formation of a receiving layer for an ink jet recording ink and the printing of variable information may be performed in the in-line method, if possible. However, all the steps may be conducted in the off-line method.

Furthermore, it is also possible to perform steps until the formation of a receiving layer for an ink jet recording ink in a printing company and to perform the printing of variable information in a company other than the printing company.

In the case of a printed matter having variable information produced by the method of the present invention, a printing ink and an ink jet recording ink do not contact directly to each other in the presence of the receiving layer. Therefore, even in the case of the combination of inks of different types such as an oil-based printing ink and a water-based ink for ink jet recording, neither repelling nor color irregularity is produced.

Furthermore, a substrate is satisfactory to have only printability to printing inks. Therefore, according to the present invention, beautiful printed matters having variable information can be obtained more inexpensively and more simply, as compared with the existing methods in which a difficult technique, i.e. a compatibility between the printability to printing inks and printability to ink jet recording inks, is required.

Moreover, in the case of a printed matter having a receiving layer all over the printed surface thereof, an ink jet recording ink can be printed in arbitrary areas. On the other hand, a printed matter having a receiving layer partially is still more economically advantageous since it can save the amount of the coating agent to be used for forming the receiving layer. Thus, much effects can be obtained.

### BEST MODE FOR CARRYING OUT THE INVENTION

The present invention will be explained concretely by reference to Examples. However, the present invention is not limited to these Examples, unless it deviates from its gist and application range. In the following description, “parts” denotes to “parts by weight”.

1) Production of Test Offset Printed Matter

A test offset printed matter was obtained by printing a lithographic ink (Diatone Ecopure SOY GP-Yellow, manufactured by Sakata Inx Corp.) to a coated paper (OK topcoat, manufactured by Oji Paper Co., Ltd.).

2) Preparation of Coating Agent for Receiving Layer and Coating Agent for Film Forming Resin

Coating agents 1 to 3, 5 to 11 for forming a receiving layer and coating agent 4 for film forming resin were prepared by charging predetermined amounts of materials according to the compositions (shown in parts by weight) given in Table 1, and then mixing with stirring by use of a high-speed mixer.

3) Production of Printed Matters of Examples 1 to 21

Production of Printed Matters of Examples by In-Line Method

Printed matters of Examples 1 to 8 were obtained as follows: Each of coating agents 1, 3, 5 to 9 and 11 for forming a receiving layer was applied by a double-coat coating method onto the ink-transferred surface of the test offset printed matter immediately after the printing, thereby forming a receiving layer. The coating amount of each receiving layer after drying was set to 4 g/m² (hereinafter the same).

A printed matter of Example 9 was obtained by applying coating agent 4 for film forming resin onto the ink-transferred surface of the test offset printed matter immediately after the printing, and then applying coating agent 2 for forming a receiving layer by a double-coat coating method, thereby forming a receiving layer. The coating amount of the film forming resin layer after drying was set to 3 g/m².

A printed matter of Example 10 was obtained by applying coating agent 10 for forming a receiving layer by a double-coat coating method onto the surface of the receiving layer obtained in Example 2, thereby forming a further receiving layer.

A printed matter of Example 11 was obtained by applying coating agent 10 for forming a receiving layer by a double-coat coating method onto the surface of the receiving layer obtained in Example 9, thereby forming a further receiving layer.

Production of Printed Matters of Examples by Off-Line Method

Printed matters of Examples 12 to 14 were obtained as follows: Each of coating agents 1, 2 and 10 for forming a receiving layer was applied by a double-coat coating method onto the ink-transferred surface of the test offset printed matter dried for one day after the printing, thereby forming a receiving layer.

Printed matters of Examples 15 and 16 were obtained as follows: Coating agent 10 for forming a receiving layer was applied by a double-coat coating method onto the surface of the receiving layer obtained in Example 12 or 13, thereby forming a receiving layer.

Production of Printed Matters Having a Receiving Layer on a Non-Printed Surface

Printed matters of Examples 17 to 19 were obtained as follows: Each of coating agents 1, 2 and 10 for forming a receiving layer was applied by a double-coat coating method onto the non-ink-transferred surface of the test offset printed matter, thereby forming a receiving layer.

Printed matters of Examples 20 and 21 were obtained as follows: Coating agent 10 for forming a receiving layer was applied by a double-coat coating method onto the surface of the receiving layer obtained in Example 17 or 18, thereby forming a further receiving layer.

In Examples 1 to 21, a flexocoater equipped with a 60 lines/cm anilox roll and a rubber roll was used for the application of the coating agent for forming a receiving layer.

TABLE 1

| Coating agent for forming | | | | | | | | | | | |
|---|---|---|---|---|---|---|---|---|---|---|---|
| receiving layer | 1 | 2 | 3 | 4 | 5 | 6 | 7 | 8 | 9 | 10 | 11 |
| Resin solution A *¹ | 79.0 | — | — | — | — | — | — | — | — | — | — |
| Resin solution B *² | — | 79.0 | 40.0 | — | — | 77.0 | 77.0 | 77.0 | 77.0 | — | — |
| Resin solution C *³ | — | — | — | — | 79.0 | — | — | — | — | — | — |
| Resin solution D *⁴ | — | — | — | — | — | — | — | — | — | 79.0 | 40.0 |
| Colloidal silica dispersion *⁵ | 20.0 | 20.0 | 20.0 | 20.0 | 20.0 | 20.0 | 20.0 | 20.0 | 20.0 | 20.0 | 20.0 |
| Surfinol 104 *⁶ | 1.0 | 1.0 | 1.0 | 1.0 | 1.0 | 1.0 | 1.0 | 1.0 | 1.0 | 1.0 | 1.0 |
| Film forming resin *⁷ | — | — | 39.0 | 99.0 | — | — | — | — | — | — | 39.0 |
| EGDE *⁸ | — | — | — | — | — | 2.0 | — | — | — | — | — |
| EGM2EH *⁹ | — | — | — | — | — | — | 2.0 | — | — | — | — |
| EGBAc *¹⁰ | — | — | — | — | — | — | — | 2.0 | — | — | — |
| SuDM *¹¹ | — | — | — | — | — | — | — | — | 2.0 | — | — |

*¹: 15% by weight aqueous solution of polyvinyl alcohol having a polymerization degree of 1,700 and a hydrolysis degree of 88% (the trade name: PVA 217, Kuraray Co., Ltd.)
*²: 10% by weight aqueous solution of polyvinyl alcohol obtained by diluting resin solution A 1.5 times with water
*³: 10% by weight ethanol solution of a lauryltrimethylammonium salt of carboxymethyl cellulose (substition degree of carboxymethyl group = 1.74)
*⁴: 10% by weight aqueous solution of cation-modified polyvinyl alcohol (Gosenol K-210, The Nippon Synthetic Chemical Industry Co., Ltd.)
*⁵: 40% by weight aqueous dispersion of Snowtex OL (manufactured by Nissan Chemical Industries, Ltd.)
*⁶: Surfactant of acetylene glycol type manufactured by Air Products and Chemicals, Inc.
*⁷: Acrylic resin emulsion containing 30 % by weight of solids obtained by a usual emulsion-polymerization method from a monomer mixture of n-octyl methacrylate/butyl acrylate/methyl methacrylate/styrene = 25/15/30/30 by weight
*⁸: Ethylene glycol diethyl ether
*⁹: Ethylene glycol mono 2-ethylhexyl ether
*¹⁰: Ethylene glycol butyl ether acetate
*¹¹: Dimethyl succinate

### COMPARATIVE EXAMPLES

The test offset printed matter immediately after the printing having no receiving layer, the printed matter dried for one day after the printing, and the coated paper having no print were used as Comparative Examples 1, 2 and 3, respectively.

4) Printing of Ink Jet Recording Ink

About 0.3 mm-wide thin lines of an indigo blue monochromic color and about 3 mm-wide thick lines of an indigo blue monochromic color and a full-color portrait image were printed with a commercially available ink jet printer (MJ-830C, piezo type, manufactured by Seiko Epson Corp., using a water-based ink) to each of the receiving layers of Examples 1 to 21, the print surfaces of Comparative Examples 1 and 2 and the surface of the paper of Comparative Example 3.

5) Evaluation

(1) Evaluation of Thin Line

Sharpness of Line

The condition of the thin lines formed by printing the ink jet recording ink was observed visually. Sharpness of the printed matters was evaluated on the basis of the presence of blurring or repelling according to the criteria that the spreading of a line twice or more in width is “blurring” and that a discontinuous thin line is “repelling”.

A: There is no blurring or repelling.

B: There is blurring or repelling.

Fixing Property

The fixing property was evaluated on the basis of the presence of smearing or fading after rubbing the printed surface with a spatula immediately after the printing.

A: There was no smearing or fading.

B: There was a little smearing or fading but the thin line was kept in its original condition.

C: There was severe smearing or fading and the line did not keep its original condition.

(2) Evaluation of Portrait Image

Muddiness

The portrait images obtained were observed visually. An image having the color tones which the inks originally have is evaluated as “there is no muddiness”, and that having muddy color tone is evaluated as “there is a muddiness.” In Comparative Examples 1 and 2, severe repelling prevented evaluation.

A: There was no muddiness.

B: There was muddiness.

(3) Evaluation of Drying Property

The drying property was evaluated on the basis of the time taken until a filter paper no longer gets colored even when the filter paper is placed on the thick lines and a load of 6,000 Pa is applied on the filter paper after a predetermined period from the time immediately after the printing of the thick lines.

A: The thick lines get dried within 2 minutes after the printing.

B: The thick lines get dried after 2 minutes but within 5 minutes from the printing.

C: The thick lines do not get dried within 5 minutes after the printing.

TABLE 2

| | Example | | | | | | | | | | | | | | | | | | | | | Com. Ex. | | |
|---|---|---|---|---|---|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 | 18 | 19 | 20 | 21 | 1 | 2 | 3 |
| Layer construction | | | | | | | | | | | | | | | | | | | | | | | | |
| (1) Coating agent | — | — | — | — | — | — | — | — | 4 | — | 4 | — | — | — | — | — | — | — | — | — | — | — | — | — |
| (2) Coating agent | 1 | 3 | 5 | 6 | 7 | 8 | 9 | 11 | 2 | 3 | 2 | 1 | 2 | 10 | 1 | 2 | 1 | 2 | 10 | 1 | 2 | — | — | — |
| (3) Coating agent | — | — | — | — | — | — | — | — | — | 10 | 10 | — | — | — | 10 | 10 | — | — | — | 10 | 10 | — | — | — |
| Performance | | | | | | | | | | | | | | | | | | | | | | | | |
| Sharpness | A | A | A | A | A | A | A | A | A | A | A | A | A | A | A | A | A | A | A | A | A | B | B | B |
| Fixing property | B | B | B | B | B | B | B | B | B | A | A | B | B | A | A | A | B | B | A | A | A | C | C | B |
| Muddiness | A | A | A | A | A | A | A | A | A | A | A | A | A | A | A | A | A | A | A | A | A | — | — | B |
| Drying property | B | B | A | A | A | A | A | B | A | A | A | A | A | B | A | A | A | A | B | A | A | C | C | C |

(1) Coating agent: coating agent for a film forming resin
(2) Coating agent: coating agent for forming a receiving layer which is the first layer from the print surface (the second layer in Examples 9 and 11)
(3) Coating agent: coating agent for forming a receiving layer which is the second layer from the print surface (the third layer in Example 11)

As described above with reference to Examples and Comparative Examples, the printed matter of the present invention is one in which usually used printing paper is employed as a substrate but beautiful images of fixed information and variable information can be formed economically and efficiently by using both printing method and ink jet recording method.

1. A printed matter having a receiving layer for an ink jet recording ink for printing variable information formed on the entire or a part of the surface of a printing paper having fixed information printed by using a printing method selected from lithographic printing, relief printing and intaglio printing.

2. The printed matter according to claim 1, wherein the receiving layer for an ink jet recording ink comprises at least two layers containing different ingredients respectively, at least one layer of them being a receiving layer comprising an ink-absorbing resin as its main ingredient and at least the other layer of them being a receiving layer comprising an ink-fixing resin as its main ingredient.

3. The printed matter according to claim 2, wherein the receiving layer comprising an ink-absorbing resin as its main ingredient is a receiving layer for an ink jet recording ink containing at least one ink-absorbing resin selected from the group consisting of proteins, starches, celluloses, polyvinyl alcohols, polyvinyl acetals and polyvinylpyrrolidones.

4. The printed matter according to claim 2 or 3, wherein the receiving layer comprising an ink-absorbing resin as its main ingredient is a receiving layer for an ink jet recording ink further containing a filler.

5. The printed matter according to claim 2 or 3, wherein the receiving layer comprising an ink-fixing resin as its main ingredient is a receiving layer for an ink jet recording ink containing at least one ink-fixing resin selected from the group consisting of resins having a cationic group in their molecules.

6. The printed matter according to any one of claims 1 to 5, wherein the receiving layer is formed at least on the print film of the ink used for printing the fixed information.

7. The printed matter according to claim 6, wherein the fixed information is printed with an oil-based ink by using the lithographic printing method or the relief printing method, and the receiving layer for an ink jet recording ink is formed at least on the print film of the oil-based ink, the receiving layer comprising one layer or two or more layers containing different ingredients, wherein the layer adjoining the print film of the oil-based ink contains a film-forming acrylic resin obtained by emulsion polymerizing monomers containing 15% by weight or more of a (meth)acrylic ester compound containing an alkyl group having 8 to 18 carbon atoms.

8. The printed matter according to claim 6 or 7, wherein the fixed information is printed with an oil-based ink by using the lithographic printing method or the relief printing method, and the receiving layer for an ink jet recording ink is formed at least on the print film of the oil-based ink, the receiving layer comprising one layer or two or more layers containing different ingredients, wherein the layer adjoining the print film of the oil-based ink is formed from a coating agent further containing 1 to 8% by weight of at least one film forming-improving agent selected from the group consisting of the compounds represented by the following general formulas (1) to (3):
Y¹—O(X¹—O)n-Z¹ (1)
Y²—O—X²—O-Z² (2)
Y³—OCO—X³—COO-Z³ (3)
wherein X¹ denotes an alkylene group having 2 to 4 carbon atoms, Y¹ and Z¹ each denote an alkyl group having 1 to 4 carbon atoms, n denotes an integer of 1 to 4; X² denotes an alkylene group having 2 to 8 carbon atoms, Y² denotes H or an alkyl group having 1 to 11 carbon atoms, Z² denotes an alkyl group having 4 to 11 carbon atoms or an acyl group having 4 to 11 carbon atoms with the proviso that Y² is H, Z² denotes an acyl group having 4 to 11 carbon atoms with the proviso that Y² is an alkyl group having 1 to 3 carbon atoms, Z² denotes an acyl group having 2 to 11 carbon atoms with the proviso that Y² is an alkyl group having 4 to 11 carbon atoms; X³ denotes a residual group of an aliphatic dibasic acid or an aromatic dibasic acid; and Y³ and Z³ each denote an alkyl group having 1 to 11 carbon atoms.

9. A printed matter, characterized in that variable information is printed by an ink jet recording method on the receiving layer recited in any one of claims 1 to 8.

10. A method for producing the printed matter according to any one of claims 2 to 8, characterized by printing fixed information and then forming the receiving layer for an ink jet recording ink with a coater or a printer by an in-line system.

11. A method for producing the printed matter according to claim 7 or 8, characterized by forming the receiving layer for an ink jet recording ink with a coater or a printer by an in-line system on a printed surface still in a wet condition immediately after printing the fixed information with an oil-based ink.

12. The method for producing a printed matter according to claim 10 or 11, wherein the receiving layer for an ink jet recording ink is formed with a coater equipped with an anilox roll and a rubber roll.
